(19) United States
(12) Patent Application Publication
(10) Pub. No.: US 2025/0230678 A1
(43) Pub. Date: Jul. 17, 2025

(54) Pool and Spa Cartridge Filter Cleaning Device

(71) Applicant: Tanya Turner, Queen Creek, AZ (US)

(72) Inventor: Tanya Turner, Queen Creek, AZ (US)

(21) Appl. No.: 18/812,321

(22) Filed: Aug. 22, 2024

Related U.S. Application Data
(60) Provisional application No. 63/621,000, filed on Jan. 15, 2024.

(51) Int. Cl. E04H 4/12; B01D 29/64; B08B 9/00

(52) U.S. Cl. CPC E04H 4/1209; B01D 29/6438; B08B 9/00

(57) ABSTRACT

A pool and spa cartridge filter cleaning device is provided. The device is comprised of a base which in one embodiment may be comprised of a rotating platform that allows a pool/spa filter cartridge to be placed and spun atop the base while being cleaned. The device also comprises a first tube with at least one opening that sprays water onto the exterior of the cartridge. A second tube, parallel to the first, is also comprised of at least one opening that allows water to clean the interior of the cartridge. Rotation of the platform is propelled by water impacting on the cartridge, which ultimately spins the platform (and cartridge) to ensure the cartridge is uniformly sprayed and cleaned.

### CROSS-REFERENCE TO RELATED APPLICATION

The present application claims priority to, and the benefit of, U.S. Provisional Application No. 63/621,000, which was filed on Jan. 15, 2024, and is incorporated herein by reference in its entirety.

### FIELD OF THE INVENTION

The present invention relates generally to the field of pool and spa cleaning devices. More specifically, the present invention relates to a device with a base that receives a pool and/or spa cartridge filter, wherein the device has tubes inside and outside of the cartridge such that water can exit the tubes to clean the filter as the filter spins atop the base. Accordingly, the present disclosure makes specific reference thereto. Nonetheless, it is to be appreciated that aspects of the present invention are also equally applicable to other like applications, devices, and methods of manufacture.

### BACKGROUND

Presently, the task of cleaning a pool or spa cartridge filter is an entirely manual, hands-on, and demanding process. More specifically, in order to clean a cartridge filter, users must painstakingly hand-wash each element, which involves manually spraying the cartridge with a hose, and then rotating and flipping the cartridge to ensure thorough cleaning. Given that there are typically four cartridges for each pool filter, the process can be quite time-consuming and labor-intensive. Furthermore, this method requires the user to be actively engaged in every stage of the cleaning process, which can be inconvenient and burdensome, especially for larger or more frequently used pools. The repetitive nature of the task, coupled with the necessity for manual operation, makes this a chore that many pool owners find cumbersome and undesirable.

Therefore, there exists a long-felt need in the art for an improved pool or spa cartridge cleaning device. There also exists a long-felt need in the art for a pool and spa cartridge filter cleaning device. More specifically, there exists a long-felt need in the art for a pool and spa cartridge filter cleaning device that can be used to quickly and efficiently clean a pool or spa filter. In addition, there exists a long-felt need in the art for a pool and spa cartridge filter cleaning device that can be used to quickly and efficiently clean a pool or spa filter without significant user involvement.

The subject matter disclosed and claimed herein, in one embodiment thereof, comprises a pool and spa cartridge filter cleaning device. The device is comprised of a base which in one embodiment may be comprised of a rotating platform that allows a pool/spa filter cartridge to be placed and spun atop the base while being cleaned. The device also comprises a first tube with at least one opening that sprays water onto the exterior of the cartridge. A second tube, parallel to the first, is also comprised of at least one opening that allows water to clean the interior of the cartridge. Rotation of the platform is propelled by water impacting on the cartridge, which ultimately spins the platform (and cartridge) to ensure the cartridge is uniformly sprayed and cleaned.

In this manner, the pool and spa cartridge filter cleaning device of the present invention accomplishes all the foregoing objectives and provides an improved pool or spa cartridge cleaning device. More specifically, the device can be used to quickly and efficiently clean a pool or spa filter. Further, the device does so without significant user involvement.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pool and spa cartridge filter cleaning device. The device is comprised of a base. The top surface of the base may also be comprised of at least one platform that rotates 360 degrees around the top surface relative to a horizontal axis of the base. As a result, a pool/spa filter cartridge can be placed on the platform and spun while being cleaned.

The device is also comprised of a first tube. The first end of the first tube may be comprised of at least one connector that allows the first tube to be connected to a water source. A portion of the first tube runs generally parallel to the vertical axis of the base. This portion of the tube is comprised of at least one opening that allows water to flow through the tube and spray onto a cartridge on the base.

The first tube is connected to a second tube via at least one removable connector. The second tube is generally parallel with the first tube. The second tube is comprised of at least one opening. In this manner, water flows out of the tube and onto the interior surface of the cartridge.

The present invention is also comprised of a method of using the device. First, a device is provided comprised of a first tube comprised of a first opening in fluid communication with a second tube comprised of a second opening via at least one connector, and a base comprised of a platform. Then, the first tube can be connected to a water supply (such as, but not limited to, a hose) via a connector. Next, the second tube can be placed inside a pool/spa filter cartridge. Then, the water supply can be turned on such that water exits the openings to clean the interior and exterior of the cartridge while the water also spins the base to ensure 360-degree cleaning of the cartridge.

Accordingly, the pool and spa cartridge filter cleaning device of the present invention is particularly advantageous as it provides an improved pool or spa cartridge cleaning device. More specifically, the device can be used to quickly and efficiently clean a pool or spa filter. Further, the device does so without significant user involvement. In this manner, the pool and spa cartridge filter cleaning device overcomes the limitations of existing headstones known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a pool and spa cartridge filter cleaning device of the present invention in accordance with the disclosed architecture;

FIG. 2 illustrates a perspective view of one potential embodiment of a pool and spa cartridge filter cleaning device of the present invention in accordance with the disclosed architecture; and

FIG. 3 illustrates a flowchart of a method of using one potential embodiment of a pool and spa cartridge filter cleaning device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved pool or spa cartridge cleaning device. There also exists a long-felt need in the art for a pool and spa cartridge filter cleaning device. More specifically, there exists a long-felt need in the art for a pool and spa cartridge filter cleaning device that can be used to quickly and efficiently clean a pool or spa filter. In addition, there exists a long-felt need in the art for a pool and spa cartridge filter cleaning device that can be used to quickly and efficiently clean a pool or spa filter without significant user involvement.

The present invention, in one exemplary embodiment, is comprised of a pool and spa cartridge filter cleaning device. The device is comprised of a base, wherein a top surface of the base may also be comprised of at least one platform that rotates 360 degrees around the top surface relative to a horizontal axis of the base in one embodiment. As a result, a pool/spa filter cartridge can be placed on the platform and spun while being cleaned.

The device is also comprised of a first tube, wherein the first end of the first tube may be comprised of at least one connector. The connector allows the first tube to be connected to a water source. A portion of the first tube runs generally parallel to the vertical axis of the base. This portion of the tube is comprised of at least one opening that allows water to flow through the tube and spray onto a cartridge on the base.

The first tube is connected to a second tube via at least one removable connector. The second tube is generally parallel to the first tube and is comprised of at least one opening. In this manner, water flows out of the tube and onto the interior surface of the cartridge.

The present invention is also comprised of a method of using the device. First, a device is provided comprised of a first tube comprised of a first opening in fluid communication with a second tube comprised of a second opening via at least one connector, and a base comprised of a platform. Then, the first tube can be connected to a water supply (such as, but not limited to, a hose) via a connector. Next, the second tube can be placed inside a pool/spa filter cartridge. Then, the water supply can be turned on such that water exits the openings to clean the interior and exterior of the cartridge while the water also spins the base to ensure 360-degree cleaning of the cartridge.

Accordingly, the pool and spa cartridge filter cleaning device of the present invention is particularly advantageous as it provides an improved pool or spa cartridge cleaning device. More specifically, the device can be used to quickly and efficiently clean a pool or spa filter. Further, the device does so without significant user involvement. In this manner, the pool and spa cartridge filter cleaning device overcomes the limitations of existing headstones known in the art.

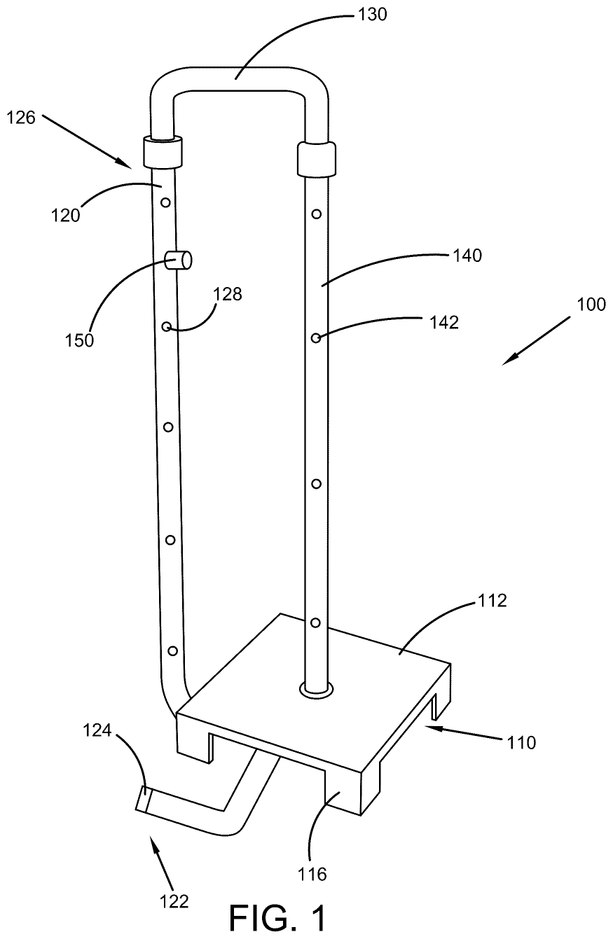

Referring initially to the drawings, FIG. 1 illustrates a perspective view of one potential embodiment of a pool and spa cartridge filter cleaning device 100 of the present invention in accordance with the disclosed architecture. The device 100 is comprised of a base 110. The base 110 may be any size, shape, and configuration. The base 110 may be comprised of at least one leg 116 of any size, shape, and configuration. The top surface 112 of the base 110 may also be comprised of at least one platform 114. The platform 114 rotates 360 degrees around the top surface 112 relative to a horizontal axis of the base 110. As a result, a pool/spa filter cartridge 10 can be placed on the platform 114 and spun while being cleaned. The platform 114 may be any size, shape, and configuration that allows the platform 114 to receive at least one cartridge 10. In one embodiment, the platform 114 is comprised of at least one fastener 115 to secure the cartridge 10 to the platform 114. The fastener 115 may include, but is not limited to, a clip, a clamp, a groove, a bolt, etc.

The device 100 is also comprised of a first tube 120. The first end 122 of the first tube 120 may be comprised of at least one connector 124 that allows the first tube 120 to be connected to a water source, such as, but not limited to, a hose. The connector 124 may be any type of hose/pipe connection known in the art such as, but not limited to, a quick-connector, a threaded connector, etc. A portion of the first tube 120 runs generally parallel with the vertical axis of the base 110. This portion of the tube 120 is comprised of at least one opening 128 that allows water to flow through the tube 120 and spray onto a cartridge 10 on the base 110. In one embodiment, the opening 128 may be comprised of at least one nozzle 150 of any size, type, and configuration that allows for adjustable placement and/or flow of water from the tube 120.

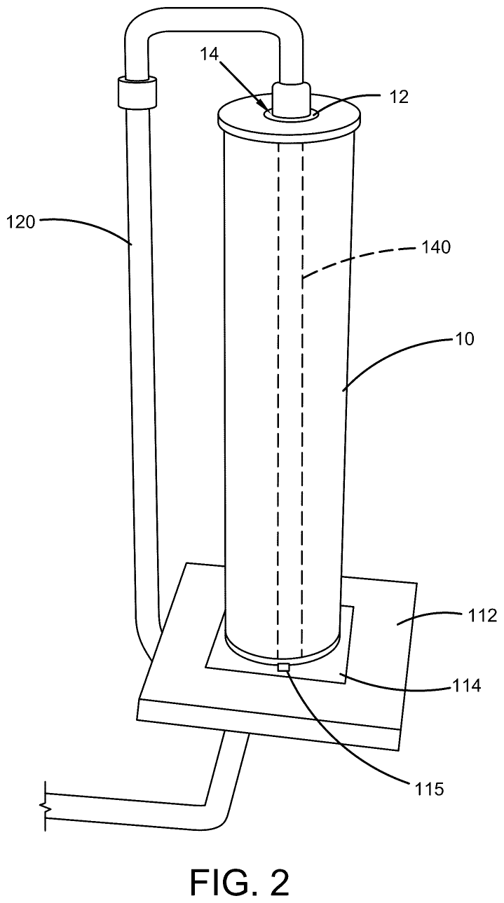

The first tube 120 is in fluid communication with a second tube 140 via at least one removable connector 124 of any size, shape, and configuration. The second tube 140 is generally parallel with the first tube 120. The second tube 140 is comprised of at least one opening 142. In the preferred embodiment, the tube 140 has a plurality of openings 142 disposed radially (or in any pattern) around the tube 140. In this manner, water flows out of the tube 140 and onto the interior surface 14 of the cartridge 10 when placed inside an opening 12 of the cartridge 10, as seen in FIG. 2. In one embodiment, the radial positioning of the openings 142 spin the base 110 to evenly clean the cartridge 10.

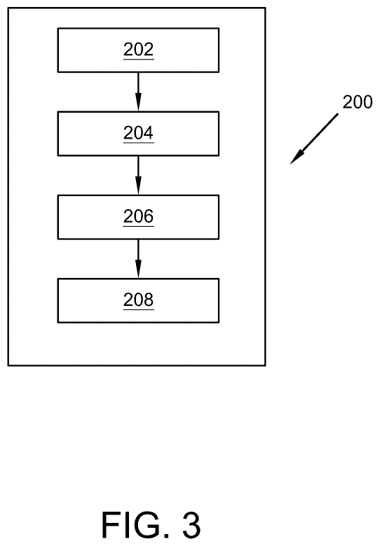

The present invention is also comprised of a method of using 200 the device 100, as seen in FIG. 3. First, a device 100 is provided comprised of a first tube 120 comprised of a first opening 128, wherein the first tube 120 is in fluid communication with a second tube 140 comprised of a second opening 142 via at least one connector 130, and a base 110 comprised of a platform 114 [Step 202]. Then, the first tube 120 can be connected to a water supply (such as, but not limited to, a hose) via a connector 124 [Step 204]. Next, the second tube 140 can be placed inside a pool/spa filter cartridge 10 [Step 206]. Then, the water supply can be turned on such that water exits the openings 128, 142 to clean the interior and exterior of the cartridge 10 while the water also spins the base 110 to ensure 360-degree cleaning of the cartridge [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pool and spa cartridge filter cleaning device” and “device” are interchangeable and refer to the pool and spa cartridge filter cleaning device 100 of the present invention.

Notwithstanding the foregoing, the pool and spa cartridge filter cleaning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the pool and spa cartridge filter cleaning device 100 as shown in the FIGS. are for illustrative purposes only, and that many other sizes and shapes of the pool and spa cartridge filter cleaning device 100 are well within the scope of the present disclosure. Although the dimensions of the pool and spa cartridge filter cleaning device 100 are important design parameters for user convenience, the pool and spa cartridge filter cleaning device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pool and spa cartridge filter cleaning device comprising:
a base;
a first tube comprised of a first opening;
a second tube comprised of a second opening; and
a first connector that places the first tube in fluid communication with the second tube.

2. The pool and spa cartridge filter cleaning device of claim 1, wherein the first tube is comprised of a second connector.

3. The pool and spa cartridge filter cleaning device of claim 1, wherein the second connector is comprised of a quick-connector or a threaded connector.

4. The pool and spa cartridge filter cleaning device of claim 1, wherein the base is comprised of a leg.

5. The pool and spa cartridge filter cleaning device of claim 1 further comprised of a nozzle.

6. A pool and spa cartridge filter cleaning device comprising:
a base comprised of a top surface, the top surface comprised of a rotating platform;
a first tube comprised of a first opening;
a second tube comprised of a second opening; and
a first connector that places the first tube in fluid communication with the second tube.

7. The pool and spa cartridge filter cleaning device of claim 6, wherein the rotating platform is comprised of a fastener.

8. The pool and spa cartridge filter cleaning device of claim 6, wherein the fastener is comprised of a clip, a clamp, a groove, or a bolt.

9. The pool and spa cartridge filter cleaning device of claim 6, wherein the rotating platform can rotate 360 degrees relative to a horizontal axis of the base.

10. The pool and spa cartridge filter cleaning device of claim 6, wherein the first tube is comprised of a second connector.

11. The pool and spa cartridge filter cleaning device of claim 6, wherein the second connector is comprised of a quick-connector or a threaded connector.

12. The pool and spa cartridge filter cleaning device of claim 6, wherein the base is comprised of a leg.

13. The pool and spa cartridge filter cleaning device of claim 6 further comprised of a nozzle.

14. A method of using a pool and spa cartridge filter cleaning device, the method comprising the following steps:
providing a pool and spa cartridge filter cleaning device comprised of a first tube comprised of a first opening, wherein the first tube is in fluid communication with a second tube comprised of a second opening via a connector, and a base comprised of a platform;
connecting the first tube to a water supply;
placing the second tube inside a cartridge;
turning on the water supply such that water exits the first opening and the second opening and cleans an interior surface and an exterior surface of the cartridge.

15. The method of using a pool and spa cartridge filter cleaning device of claim 14, wherein the cartridge is comprised of a pool filter cartridge.

16. The method of using a pool and spa cartridge filter cleaning device of claim 14, wherein the cartridge is comprised of a spa filter cartridge.

17. The method of using a pool and spa cartridge filter cleaning device of claim 14, wherein the platform can rotate 360 degrees relative to a horizontal axis of the base.

18. The method of using a pool and spa cartridge filter cleaning device of claim 14, wherein the first tube is comprised of a second connector.

19. The method of using a pool and spa cartridge filter cleaning device of claim 14, wherein the first tube is comprised of a nozzle.

20. The method of using a pool and spa cartridge filter cleaning device of claim 18, wherein the second connector is comprised of a quick connector or a threaded connector.
